(19) United States
(12) Patent Application Publication
(10) Pub. No.: US 2011/0225399 A1
(43) Pub. Date: Sep. 15, 2011

(54) PROCESSOR AND METHOD FOR SUPPORTING MULTIPLE INPUT MULTIPLE OUTPUT OPERATION

(75) Inventors: Tai-Song JIN, Seoul (KR); Dong-Hoon Yoo, Seoul (KR); Bernhard Egger, Seoul (KR); Won-Sub Kim, Anyang-si (KR)

(73) Assignee: SAMSUNG ELECTRONICS CO., LTD., Suwon-si (KR)

(21) Appl. No.: 12/964,377

(22) Filed: Dec. 9, 2010

(30) Foreign Application Priority Data
Mar. 12, 2010 (KR) 10-2010-0022493

(51) Int. Cl. G06F 9/30

(52) U.S. Cl. 712/220; 712/E09.016

(57) ABSTRACT

A processor for supporting a MIMO operation and method of processing a MIMO instruction are provided. The MIMO operation supporting processor may include a scheduler and at least one functional unit. The scheduler may map multiple inputs of the MIMO instruction to a plurality of sequential input cycles, respectively, and may map multiple outputs of the MIMO instruction to a plurality of sequential output cycles, respectively. The output cycles may be followed by the input cycles and a predetermined number of cycles for a MIMO operation. A functional unit may read a register during sequential input cycles, may perform a MIMO operation during a predetermined number of execution cycles, and may write the result of the MIMO operation into a register during sequential output cycles.

### CROSS-REFERENCE TO RELATED APPLICATION(S)

This application claims the benefit under 35 U.S.C. §119(a) of Korean Patent Application No. 10-2010-0022493, filed on Mar. 12, 2010, in the Korean Intellectual Property Office, the entire disclosure of which is incorporated herein by reference for all purposes.

### BACKGROUND

1. Field

The following description relates to a computer processor, and more particularly, to a process for supporting Multiple-Input Multiple-Output (MIMO) operation.

2. Description of the Related Art

Complex instruction set computing is a computer instruction set architecture in which each instruction can execute several low-level operations, such as a load from memory, an arithmetic operation, and a memory store, all in a single instruction. A “complex instruction” refers to an instruction of simultaneously processing several basic operations, for example, a Multiply and ACcumulate (MAC) operation which allows first input data to be multiplied by second input data and the result of multiplication to be added to third input data. Other examples of complex instructions include: saving many registers on the stack at once, moving large blocks of memory, complex and/or floating-point arithmetic (sine, cosine, square root, etc.), performing an atomic test-and-set instruction, and instructions that combine ALU with an operand from memory rather than a register. By using such a complex instruction, the number of registers and cycles required to process a plurality of basic operations are reduced, as compared with instructions in which the basic operations are consecutively processed. In particular, the complex instruction is useful in improving the performance of a multimedia application that needs to repeat a predetermined type of operation.

In general, such a complex instruction requires multiple inputs (at least three) and/or multiple outputs (at least two). A “Multiple Input Multiple Output (MIMO) instruction” refers to a complex instruction with input and output, in which at least one of which is implemented as a multiple. A “MIMO operation” is defined as an operation that is performed in a processor run by the MIMO instruction.

In one approach to processing the MIMO instruction, a processor or a Functional Unit (FU) may be configured to have at least three input register ports and at least two output register ports. Alternatively, using another method, an interconnection may be installed to connect at least two adjacent FUs to each other in a processor including a plurality of FUs such that the FUs connected to each other simultaneously executes a plurality of basic operations at a single cycle. However, as described above, these two methods require additional hardware such as input/output ports or interconnection.

### SUMMARY

In one general aspect, there is provided a processor for supporting a Multiple Input Multiple Output (MIMO) operation, the processor including: a scheduler configured to: map multiple inputs of a MIMO instruction to K sequential cycles, K being an integer greater than or equal to 2, respectively, and map multiple outputs of the MIMO instruction to L sequential cycles, L being an integer greater than or equal to 2, and a functional unit (FU) configured to: read a register during the K sequential cycles to execute a MIMO operation, and write a result of the MIMO operation into a register during the L sequential cycles.

In the processor, the FU may include: a reading unit configured to read multiple pieces of input data from the register during respective K sequential cycles, a MIMO executing unit configured to: generate multiple pieces of output data by receiving the multiple pieces of input data from the reading unit, and execute the MIMO operation during a predetermined number of cycles, and a writing unit configured to write the multiple pieces of output data received from the MIMO executing unit into the register during respective L sequential cycles.

In the processor, the reading unit may be further configured to simultaneously transfer the multiple pieces of input data to the MIMO executing unit, and the MIMO executing unit may be further configured to simultaneously transfer the multiple pieces of output data to the writing unit.

In the processor, a plurality of the FUs may be provided, and the scheduler may be further configured to map the multiple inputs and the multiple outputs to at least two FUs which are connected to each other.

In the processor, the FU may include two input register ports and one output register port.

In the processor, the processor may be configured to use a fixed bit instruction encoding.

In the processor, the processor may be configured to support a Very Long Instruction Word (VLIW).

In another general aspect, there is provided a method of processing a Multiple Input Multiple Output (MIMO) instruction in a processor, the method including: reading multiple pieces of input data from a register during a single cycle or during K sequential cycles, K being an integer greater than or equal to 2, generating multiple pieces of output data by executing a MIMO operation during a predetermined number of cycles by use of the multiple pieces of input data, and writing the multiple pieces of output data into a register during a single cycle or during L sequential cycles, L being an integer greater than or equal to 2, wherein at least one of the reading of multiple pieces of input data and the writing of multiple pieces of output data is performed during a plurality of cycles.

In the method, the processor may include a plurality of functional units (FUs), and the reading of multiple pieces of input data, the executing of MIMO operation, and the writing of multiple pieces of output data may be performed by one of the plurality of FUs.

In the method, the processor may include a plurality of functional units (FUs), and the reading of multiple pieces of input data and the writing of multiple pieces of output data may be performed by at least two of the plurality of FUs that are connected to each other.

In the method, the executing MIMO operation may be performed by at least two of the plurality of FUs that are connected to each other.

In the method, in the reading of multiple pieces of input data, at most two pieces of input data may be read from the register at each of the K sequential cycles, and in the writing of multiple pieces of output data, at most one piece of output data may be written into the register at each of the K sequential cycles.

The method may further include using a fixed bit instruction encoding.

The method may further include supporting a Very Long Instruction Word (VLIW).

In another general aspect, there is provided a method of processing a Multiple Input Multiple Output (MIMO) instruction in a processor, the method including at least one of: processing multiple inputs of the MIMO instruction by reading a register during K sequential cycles, K being an integer greater than or equal to 2, and processing multiple outputs of the MIMO instruction by executing a MIMO operation, and then writing a result of the MIMO operation into a register during L sequential cycles, L being an integer greater than or equal to 2.

The method may further include performing scheduling in which at least one of: the multiple inputs are mapped to the K sequential cycles, and the multiple outputs are mapped to the L sequential cycles.

In the method, the processor may include a plurality of functional units (FUs), and the scheduling may be performed such that the multiple inputs and the multiple outputs are processed by one of the plurality of FUs.

In the method, the processor may include a plurality of functional units (FUs), and the scheduling may be performed such that the multiple inputs and the multiple outputs are processed by at least two of the plurality of FUs which are connected to each other.

In the method, the MIMO operation may be performed by one of the at least two of the plurality of FUs that are connected to each other.

In the method, the processor may include a plurality of functional units (FU), and each of the plurality of FUs: may read at most two pieces of input data from the register for each cycle of the K sequential cycles, and may write at most one piece of output data into the register for each cycle of the L sequential cycles.

Other features and aspects may be apparent from the following detailed description, the drawings, and the claims.

### BRIEF DESCRIPTION OF THE DRAWINGS

FIG. 1 shows a configuration of an example of a processor for supporting a Multiple Input Multiple Output (MIMO) operation.

FIG. 2 shows an example of a sequence of processing a Multiple Input Multiple Output (MIMO) instruction in a Functional Unit (FU) shown in FIG. 1.

FIG. 3 shows MIMO instructions for four inputs and two outputs.

FIG. 4 shows another example of a sequence of processing a Multiple Input Multiple Output (MIMO) instruction in a Functional Unit (FU) shown in FIG. 1.

FIG. 5 shows MIMO instructions having six inputs and four outputs.

FIG. 6 shows a configuration of another example of a processor for supporting a Multiple Input Multiple Output (MIMO) operation.

FIG. 7 shows an example of a sequence of processing a Multiple Input Multiple Output (MIMO) instruction in a Functional Unit (FU) shown in FIG. 6.

FIG. 8 shows a MIMO instruction having eight inputs and four outputs.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

Examples will be described with reference to accompanying drawings in detail.

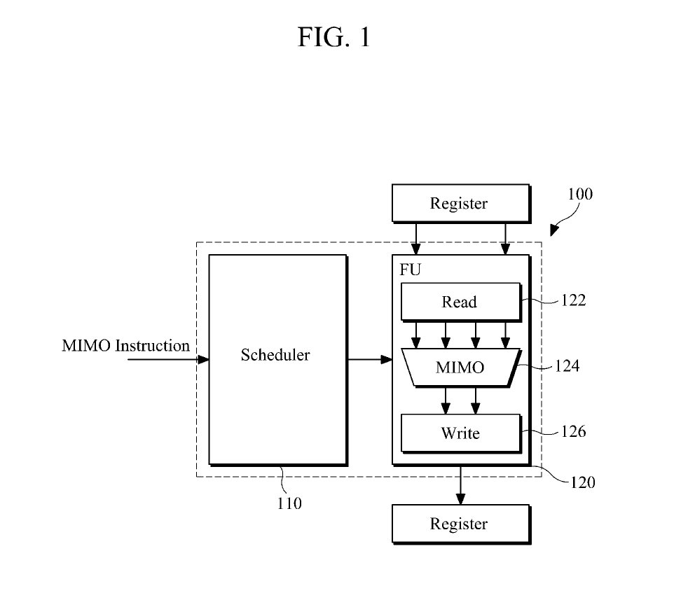

FIG. 1 shows a configuration of an example of a processor for supporting a Multiple Input Multiple Output (MIMO) operation. As shown in FIG. 1, a processor 100 for supporting a Multiple Input Multiple Output (MIMO) operation may include a scheduler 110 and a Functional Unit (FU) 120. A single FU or a plurality of FUs may be provided. As an example, in FIG. 1, the MIMO operation will be described such that the processor 100 has a single FU and the FU includes two fixed input register ports and one fixed output register port. The term of “Multiple” may be qualified due to the number of input/output register ports of the FU. The processor 100 shown in FIG. 1 has two separate registers, but the register may be provided as a single unit. More than one processor may be provided.

In a broad sense, the MIMO operation represents an operation that is executed by a complex instruction having at least one multiple input and output. For example, at least three inputs may be provided and at least two outputs may be provided. However, in a more narrow sense, the MIMO operation represents an operation that is executed by a complex instruction having multiple inputs and multiple outputs. For example, an operation executed by an instruction having two inputs and one output, or by an instruction having two inputs and two outputs may be classified into the MIMO operation in a broad sense but not in a narrow sense. Meanwhile, an operation executed by an instruction having at least three inputs and at least two outputs may be classified as the MIMO operation. The processor 100 may support the narrow sense-MIMO operation or the broad sense-MIMO operation.

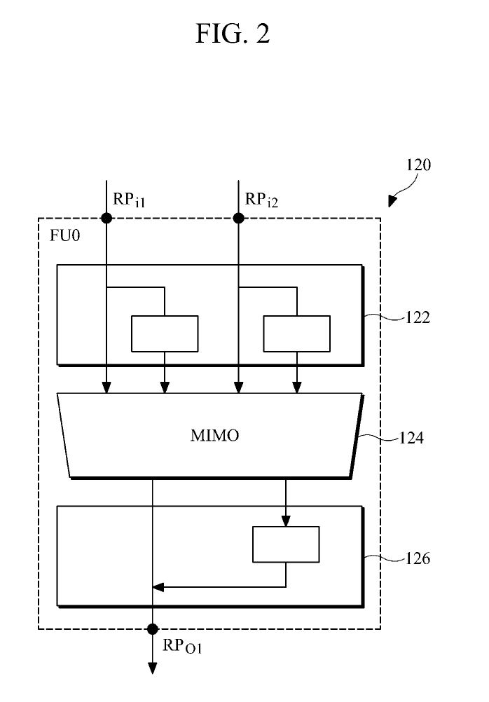

The processor 100 may include an input register port RPᵢ and an output register port RP_{O} used for the FU 120 (see FIG. 2). A fixed number of input resistor ports RPᵢ and output register ports RP_{O} may be provided. An example of the processor 100 may include two input register ports and one output register port, although various numbers of the input register port and output register port may be provided. The example of the FU 120 may read data from at most two registers or may record data into at most one register during a single cycle. Accordingly, in order to perform an MIMO operation of inputting and/or outputting data greater than the fixed number of ports, the FU 120 may read a register from a register during a plurality of sequential cycles, and/or may write data into a register during a plurality of sequential cycles.

The processor 100 may be a device using a fixed bit instruction encoding. For example, the processor 100 may use a single register file having a size of 64 bits or 128 bits. If the processor 100 uses a fixed instruction encoding, data processing speed may be improved.

The processor 100 may further include a Very Long Instruction Word (VLIW) machine for supporting the MIMO operation. The VLIW machine represents a Central Processing Unit (CPU) architecture that may be designed to take advantage of Instruction Level Parallelism (ILP). The VLIW machine may include a plurality of FUs to process a plurality of instructions simultaneously. At least one of the FUs may perform an MIMO operation. Input instructions may be grouped into as many instruction bundles as respective FUs, and instructions included in a single instruction bundle may be distributed to respective FUs and simultaneously processed. The VLIW machine may include a limited number of input register ports and output register ports, and may usea fixed bit instruction encoding.

The processor 100 may process multiple inputs and multiple outputs of the MIMO instruction by grouping the multiple inputs into multi-cycle inputs and grouping the multiple outputs into multi-cycle outputs. The “multi-cycle input” refers to a register reading that is performed by a single FU 120 over a plurality of sequential cycles, and the “multi-cycle output” refers to a register writing that is by performed by a single FU 120 over a plurality of sequential cycles. However, it should be appreciated that the processor 100 may not need to group inputs or outputs among cycles if the MIMO instruction uses two inputs or one output. In order to process multiple inputs and/or multiple outputs during a plurality of respective cycles, the processor 100 may include a scheduler 110. The term “scheduler” is arbitrarily selected and the scheduler 120 may be referred to using another term, for example, a “mapper” or a “controller.” The scheduler 110 may map multiple inputs of the MIMO instruction to K sequential cycles, in which K is an integer greater than or equal to 2. The scheduler 110 may map multiple outputs of the MIMO instruction to L sequential cycles, in which L is an integer greater than or equal to 2. It is obvious that the L sequential cycles mapping to the multiple outputs may be followed by the K sequential cycles and one or more cycles for a MIMO operation.

The FU 120 may perform the MIMO operation using multiple pieces of input data which are fetched by reading a register during the K sequential cycles mapped by the scheduler 110. The FU 120 may write multiple pieces of output data which are obtained through the MIMO operation into the register during the L sequential cycles mapped by the scheduler 120. As such, the FU 120 may include a reading unit 122, an MIMO executing unit 124, and a writing unit 126. The reading unit 122, the MIMO executing unit 124, and the writing unit 126 may be subdivided in a logic terms, but at least two of the reading unit 122, the MIMO executing unit 124, and the writing unit 126 may be integrated. However, such a logical division of the reading unit 122, the MIMO executing unit 124, and the writing unit 126 is qualified for the sake of convenience, and the functions of the components is not fixed. Any combination of integrating the reading unit 122, the MIMO executing unit 124, and the writing unit 126 may be used.

The reading unit 122 may read multiple pieces of input data from the register during respective K sequential cycles mapped by the scheduler 110. During each cycle of the K sequential cycles, the reading unit 122 may read from, at most, a number of registers corresponding to the number of input register ports, which are included in the FU 120. In addition, the reading unit 122 may simultaneously transfer multiple pieces of input data read during the K sequential cycles to the MIMO executing unit 124.

The MIMO executing unit 124 may perform an MIMO operation by use of the multiple pieces of input data that are simultaneously read by the reading unit 122. The number of cycles operating in the MIMO executing unit 124 is not limited, and may vary depending on an algorithm of the MIMO operation. As a result of the MIMO operation, the MIMO executing unit 124 may generate multiple pieces of output data, and may transfer the multiple pieces of output data together to the writing unit 126.

The writing unit 126 may write the multiple pieces of output data into a register during respective L sequential cycles mapped by the scheduler 110. During each cycle of the L sequential cycles, the writing unit 126 may write to, at most, a number of registers corresponding to the number of output register ports that are included in the FU 120. In this manner, the multiple pieces of output data may be simultaneously transferred from the MIMO executing unit 124 to the writing unit 126, but the writing unit 126 may write the multiple pieces of output data during respective L sequential cycles.

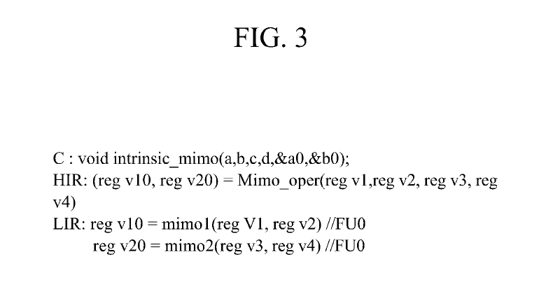

FIG. 2 illustrates an example of a sequence of processing a Multiple Input Multiple Output (MIMO) instruction in the Functional Unit (FU) 100 shown in FIG. 1. FIG. 2 shows an example in which the MIMO operation according to an MIMO instruction has four inputs and two outputs. When four inputs and two outputs are desired to be performed in the FU 120 having two input register ports RPᵢ₁ and RPᵢ₂ and one output register port RP_{O1}, a MIMO instruction for the four inputs and two outputs may have the structure as shown in the example of FIG. 3. In FIG. 3, “FU0” represents any one of the FUs included in the processor 100.

If the MIMO instruction shown in FIG. 3 is input, the scheduler 110 (see FIG. 1) may map registers (reg v1, reg v2) and (reg v3, reg v4) corresponding to the multiple inputs for the FU0 to two sequential cycles (hereinafter, referred to as “input cycles”), and may map registers (reg v10, reg v20) corresponding to the multiple outputs for the FU0 to two sequential cycles (hereinafter, referred to as “output cycles”). It should be appreciated that the two sequential output cycles may be followed the two sequential input cycles and a predetermined number of cycles for a MIMO operation.

The reading unit 122 may read the four registers (reg v1, reg v2, reg v3, and reg v4) over the two sequential input cycles that are scheduled by the scheduler 110. Input data read at the first input cycle of the two sequential input cycles, e.g., input data of reg v1 and reg v2, may be held during one cycle and transferred to the MIMO executing unit 124 together with input data, which may be read at the second input cycle, e.g., input data of reg v3 and reg v4. In FIG. 2, a path of the input data that are input at the second input cycle is represented as arrows directly running from the input register ports RPᵢ₁ and RPᵢ₂ to the MIMO executing unit 124. Also in FIG. 2, a path of the input data that are input at the first input cycle is represented as arrows running from the input register ports RPᵢ₁ and RPᵢ₂ to the MIMO executing unit 124 through a small box included in the reading unit 122.

The MIMO executing unit 124 may perform a MIMO operation by use of the received multiple pieces of input data. After the sequential input cycles, e.g., the K cycles, the MIMO operation may proceed during at least one cycle, hereinafter, referred to an “execution cycle.” The MIMO executing unit 124 may simultaneously transfer multiple pieces of output data that are generated as a result of MIMO operation to the writing unit 126.

The writing unit 126 may write one of the multiple pieces of output data transferred from the MIMO executing unit 124 into a register, for example, reg v10 at the first output cycle of the two sequential output cycles. The writing unit 126 may write the remaining of the multiple pieces of output data transferred from the MIMO executing unit 124 into registers, for example, reg v20 at the second output cycle of the two sequential output cycles. In FIG. 2, a path of the output data that are output at the first output cycle is represented as an arrow directly running from the MIMO executing unit 124 to the output register port RP_{O1}. Also in FIG. 2, a path of the output data that are output at the second output cycle is represented as an arrow running from the MIMO executing unit 124 to the output register port RP_{O1} through a small box included in the writing unit 122.

As described above, the example of the processor 100 including the FU 120 shown in FIG. 2 requires four cycles and a predetermined number of execution cycles to process an MIMO instruction having four inputs and two outputs. That is, the MIMO instruction may be processed with only four cycles and a predetermined number of execution cycles using a single FU 120. The example of the FU 120 may enhance the efficiency in processing a MIMO instruction requiring at least three execution cycles, as compared to an instance in which performing a MIMO operation using two FUs connected to each other in a conventional processor. This is because the conventional processor requires (2*(two cycles+execution cycles)) when processing four inputs and two outputs, in which “2” denotes the number of FUs and “two cycles” represents the total cycles, e.g., the K or L cycles, required to process the input and output data.

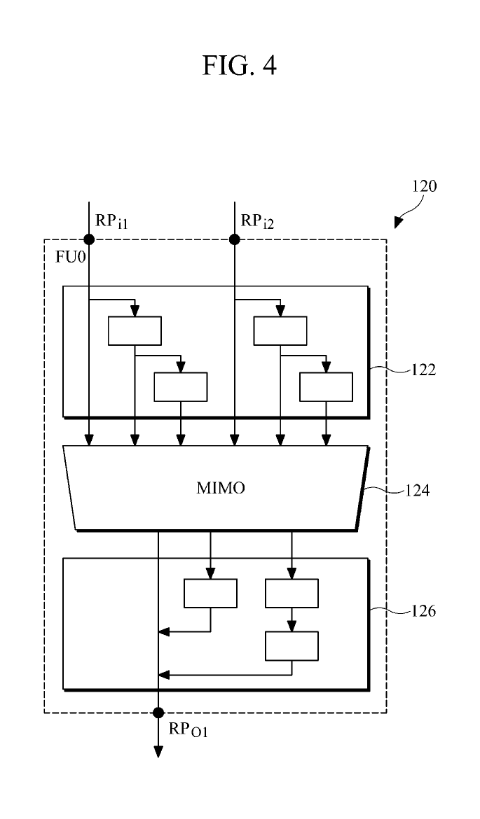

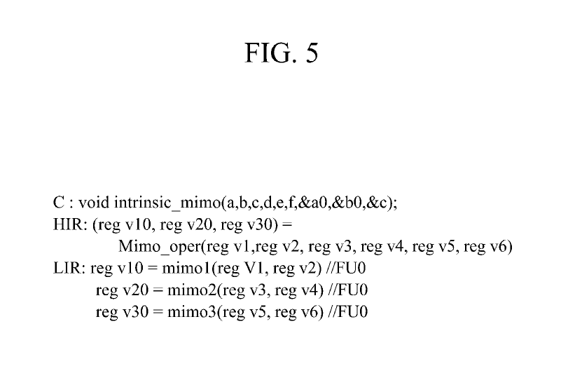

FIG. 4 shows another example of a sequence of processing a Multiple Input Multiple Output (MIMO) instruction in the Functional Unit (FU) 100 shown in FIG. 1. FIG. 4 shows an example in which the MIMO operation according to an MIMO instruction has six inputs and three outputs. When six inputs and three outputs are desired to be performed in the FU 120 having two input register ports RPᵢ₁ and RPᵢ₂ and one output register port RP_{O1}, a MIMO is instruction for the six inputs and three outputs may have the structure as shown in the example of FIG. 5. In FIG. 5, “FU0” represents any one of the FUs included in the processor 100.

If a MIMO instruction shown in FIG. 5 is input, the scheduler 110 (see FIG. 1) may map registers (reg v1, reg v2), (reg v3, reg v4), and (reg v5, reg v6) corresponding to the multiple inputs for the FU0 to three sequential cycles (hereinafter, referred to as “input cycles”), and may map registers (reg v10, reg v20, reg v30) corresponding to the multiple outputs for the FU0 to three sequential cycles (hereinafter, referred to as “output cycles”). It should be appreciated that the three sequential output cycles may be followed by the three sequential input cycles and a predetermined number of cycles for a MIMO operation.

The reading unit 122 may read the six registers (reg v1, reg v2, reg v3, reg v4, reg v5, and reg v6) over the three sequential input cycles that are scheduled by the scheduler 110. Input data read at the first input cycle, e.g., input data of reg v1 and reg v2, may be held during two cycles. Input data read at the second input cycle, e.g., input data of reg v3 and reg v4, may be held during one cycle. The input data of reg v1, reg v2, reg v3, and reg v4 may be transferred to the MIMO executing unit 124 together with input data read at the third input cycle, for example, reg v5 and reg v6. In FIG. 4, a path of the input data that are input at the third input cycle is represented as arrows directly running from the input register ports RPᵢ₁ and RPᵢ₂ to the MIMO executing unit 124. Also in FIG. 4, a path of the input data that are input at the second input cycle is represented as arrows running to the MIMO executing unit 124 through a small box included in the reading unit 122. In addition, in FIG. 4, a path of the input data that are input at the first input cycle is represented as arrows running from the input register ports RPᵢ₁ and RPᵢ₂ to the MIMO executing unit 124 through two small boxes included in the reading unit 122.

The MIMO executing unit 124 may perform a MIMO operation by use of the received multiple pieces of input data. After the sequential input cycles, the MIMO operation may is proceed for at least one cycle. The MIMO executing unit 124 may simultaneously transfer multiple pieces of output data that are generated as a result of MIMO operation to the writing unit 126.

The writing unit 126 may write one of the multiple pieces of output data transferred from the MIMO executing unit 124 into a register, e.g., reg v10, at the first output cycle of the three sequential output cycles. The writing unit 126 may write the second output data of the output data transferred from the MIMO executing unit 124 into a register, e.g., reg v20, at the second output cycle of the three sequential output cycles. The writing unit 126 may write the third output data of the output data transferred from the MIMO executing unit 124 into a register, e.g., reg v30, at the last output cycle of the three sequential output cycles. In FIG. 4, a path of the output data that are output at the first output cycle is represented as an arrow directly running from the MIMO executing unit 124 to the output register port RP_{O1}. Also in FIG. 4, a path of the output data that are output at the second output cycle is represented as an arrow running to the output register port RP_{O1} through a small box included in the writing unit 122. In addition, in FIG. 4, a path of the output data that are output at the third output cycle is represented as an arrow running from the MIMO executing unit 124 to the output register port RP_{O1} through two small boxes included in the writing unit 122.

It should be appreciated that the FU 120 of the processor 100 shown in FIG. 1 may be capable of processing MIMO instructions other than the above MIMO instruction. For example, if a MIMO operation has at least seven inputs and/or four outputs, the processor 100 may increase the input cycle to at least seven and/or the output cycle to at least four.

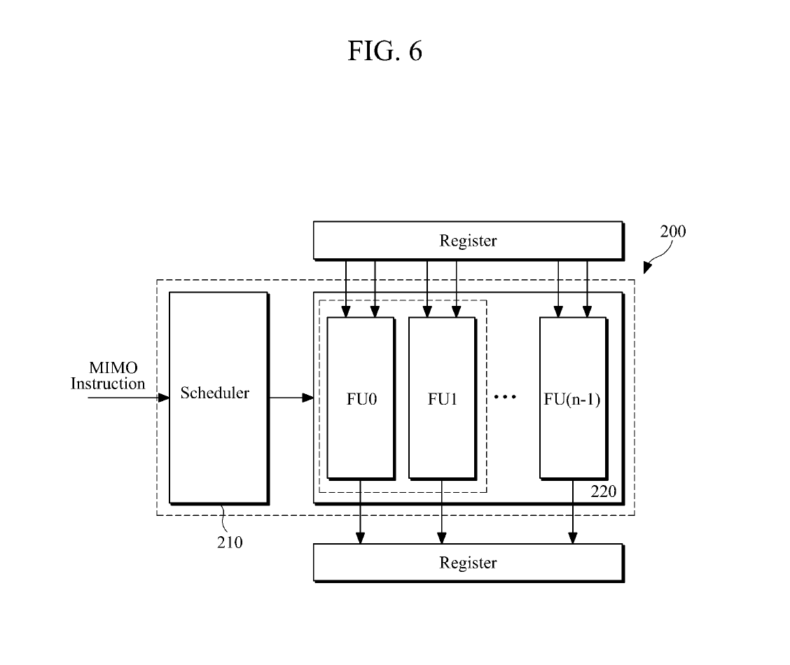

FIG. 6 shows a configuration of another example of a processor for supporting a Multiple Input Multiple Output (MIMO) operation. As shown in FIG. 6, a processor 200 for supporting a Multiple Input Multiple Output (MIMO) operation may include a scheduler 210 and n Functional Units 220, including a first Functional Unit to an nₜₕ Functional Unit (FU0 to FU(n−1)), in which n is an integer greater than or equal to 2. At least two adjacent FUs may be connected to each other. In FIG. 6, as an example, the first Functional Unit (FU0) may be connected to the second Functional Unit (FU1). Similar to FIG. 2, the MIMO operation will be described in an example in which each Functional Unit (FU0 to FU(n−1)) has two fixed input register ports and one fixed output register port. The descriptions made in relation to the processor 100 with reference to FIG. 1, for example, the definition of the “MIMO operation,” the details of the use of the fixed input/output register ports and fixed bit instruction encoding, and the inclusion of the VLIW machine are applied to the processor 200.

The processor 200 may process multiple inputs and multiple outputs of the MIMO operation by grouping the multiple inputs into multiple cycle inputs and grouping the multiple outputs into multiple cycle outputs. For example, the processor 200 may allow the FU0 and FU1 to process the multiple inputs and multiple outputs in cooperation with each other. In order for the Function Units (FU0 and FU1) to process multiple inputs and/or multiple outputs during a plurality of respective cycles, the processor 200 may include a scheduler 210. The scheduler 210 may map multiple inputs of the MIMO instruction to K sequential cycles, in which K is an integer greater than or equal to 2. The scheduler 110 may map multiple outputs of the MIMO instruction to L sequential cycles, in which L is an integer greater than or equal to 2.

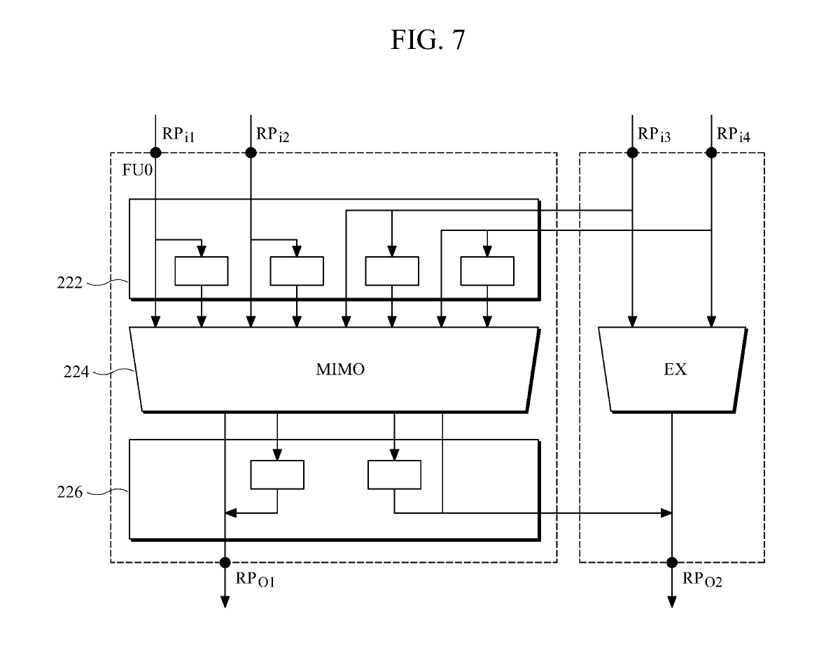

The Functional Units (FU0 and FU1) connected to each other may read a register during the K sequential cycles mapped by the scheduler 210 and one of the Functional Units. For example, FU0 may perform a MIMO operation by use of multiple pieces of input data. The Functional Units (FU0 and FU1) may write multiple pieces of output data, which are obtained through the MIMO operation, into the register during the L sequential cycles mapped by the scheduler 210. As such, the Functional Units (FU0 and FU1) may include a reading unit 222, a MIMO executing unit 224, and a writing unit 226 (see FIG. 7).

As shown in FIGS. 6 and 7, the reading unit 222 may read multiple pieces of input data from the register during respective K sequential cycles mapped by the scheduler 210. During each cycle of the K sequential cycles, the reading unit 222 may read from, at most, a number of registers corresponding to the number of input register ports that are included in the Functional Units (FU0 and FU1). In addition, the reading unit 222 may simultaneously transfer multiple pieces of input data, which are read during the K sequential cycles, to the MIMO executing unit 124.

The MIMO executing unit 224 may perform an MIMO operation by use of the multiple pieces of input data that are simultaneously from the reading unit 222. The number of cycles operating in the MIMO executing unit 224 is not limited, and may vary depending on an algorithm of the MIMO operation. As a result of the MIMO operation, the MIMO executing unit 224 may generate multiple pieces of output data, and may simultaneously transfer the multiple pieces of output data to the writing unit 226.

The writing unit 226 may write the multiple pieces of output data into the register during respective L sequential cycles mapped by the scheduler 210. During each cycle of the L sequential cycles, the writing unit 226 may write to, at most, a number of registers corresponding to the number of output register ports that are included in the Functional Units (FU0 and FU1) 220. In this manner, the multiple pieces of output data may be simultaneously transferred from the MIMO executing unit 224 to the writing unit 226, but the writing unit 226 may write the multiple pieces of output data during respective L sequential cycles.

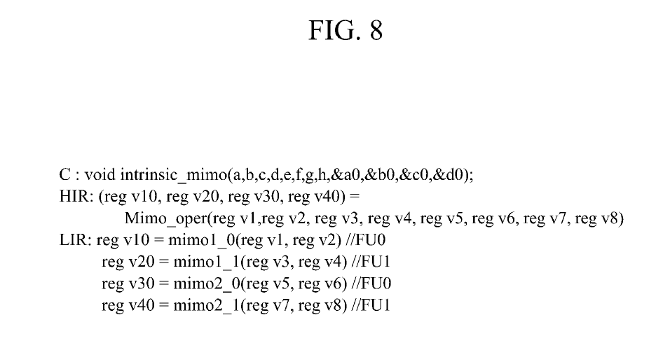

FIG. 7 shows an example of a sequence of processing a Multiple Input Multiple Output (MIMO) instruction in the Functional Units (FU0 and FIG. 1) shown in the example of FIG. 6. FIG. 7 shows an example in which the MIMO operation according to an MIMO instruction has eight inputs and four outputs. When eight inputs and four outputs are desired to be performed in the Functional Units (FU0 and FU1) having four input register ports RPᵢ₁, RPᵢ₂ RPᵢ₃, and RPᵢ₄ and two output register ports RP_{O1i} and RP_{O2}, a MIMO instruction for the eight inputs and four outputs may have the structure as shown in the example of FIG. 8.

If a MIMO instruction shown in FIG. 8 is input, the scheduler 210 (see FIG. 6) may map registers (reg v1, reg v2), (reg v3, reg v4), (reg v5, reg v6), and (reg v7, reg v8) corresponding to the multiple inputs for the FU0 and FU1 to two sequential cycles (hereinafter, referred to as “input cycles”), and may map registers (reg v10, reg v20) and (reg v30, reg v40) corresponding to the multiple outputs for the FU0 and FU1 to two sequential cycles (hereinafter, referred to as “output cycles”). It should be appreciated that the two sequential output cycles may be followed by the two sequential input cycles and a predetermined number of cycles for a MIMO operation.

The reading unit 222 may read the eight registers (reg v1, reg v2, reg v3, reg v4, reg v5, reg v6, reg v7, and reg v8) over the two sequential input cycles that are scheduled by the scheduler 210. Input data read at the first input cycle of the two sequential input cycles, e.g., input data of reg v1 to reg v4, may be held for one cycle and transferred to the MIMO executing unit 224 together with input data which are read at the second input cycle, e.g., input data of reg v5 to reg v8. In FIG. 7, a path of the input data that are input at the second input cycle is represented as an arrow directly running from the input register ports RPᵢ₁, RPᵢ₂ RPᵢ₃, and RPᵢ₄ to the MIMO executing unit 224. Also in FIG. 7, a path of the input data that are input at the first input cycle is represented as arrows running from the input register ports RPᵢ₁, RPᵢ₂ RPᵢ₃, and RPᵢ₄ to the MIMO executing unit 224 through a small box included in the reading unit 222.

The MIMO executing unit 224 may perform a MIMO operation by use of the received multiple pieces of input data. After the sequential input cycles, the MIMO operation may proceed for at least one execution cycle. The MIMO executing unit 224 may transfer multiple pieces of output data that are generated as a result of MIMO operation to the writing unit 226.

The writing unit 226 may write one of the multiple pieces of output data transferred from the MIMO executing unit 224 into registers, e.g., reg v10 and reg v20, at the first output cycle of the two sequential output cycles. The writing unit 226 may write the remaining of the multiple pieces of output data transferred from the MIMO executing unit 224 into registers, e.g., reg v30 and reg v40, at the second output cycle of the two sequential output cycles. In FIG. 7, a path of the output data that are output at the first output cycle are represented as arrows directly running from the MIMO executing unit 224 to the output register ports RP_{O1} and RP_{O2}. Also in FIG. 7, paths of the output data that are output at the second output cycle are represented as arrows running from the MIMO executing unit 224 to the output register ports RP_{O1} and RP_{O1} by passing through small boxes.

Different from the processor 100 shown in FIG. 1, the processor 200 may further include interconnections to reduce the number of input cycles and/or output cycles, increasing operation speed.

As described above, the processor for supporting a MIMO operation may relieve or minimize the need for additional hardware used to process a MIMO instruction, such as a register port or interconnections, such that the structure of the processor is simpler. In addition, the processor for supporting a MIMO operation may minimize the use of the registers for processing a MIMO operation, and may increase the processing speed.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

As a non-exhaustive illustration only, the device described herein may refer to mobile devices such as a cellular phone, a personal digital assistant (PDA), a digital camera, a portable game console, and an MP3 player, a portable/personal multimedia player (PMP), a handheld e-book, a portable tablet and/or laptop PC, a global positioning system (GPS) navigation, and devices such as a desktop PC, a high definition television (HDTV), an optical disc player, a setup and/or set top box, and the like consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of example embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A processor for supporting a Multiple Input Multiple Output (MIMO) operation, the processor comprising:
a scheduler configured to:
map multiple inputs of a MIMO instruction to K sequential cycles, K being an integer greater than or equal to 2, respectively; and
map multiple outputs of the MIMO instruction to L sequential cycles, L being an integer greater than or equal to 2; and
a functional unit (FU) configured to:
read a register during the K sequential cycles to execute a MIMO operation; and
write a result of the MIMO operation into a register during the L sequential cycles.

2. The processor of claim 1, wherein the FU comprises:
a reading unit configured to read multiple pieces of input data from the register during respective K sequential cycles;
a MIMO executing unit configured to:
generate multiple pieces of output data by receiving the multiple pieces of input data from the reading unit; and
execute the MIMO operation during a predetermined number of cycles; and
a writing unit configured to write the multiple pieces of output data received from the MIMO executing unit into the register during respective L sequential cycles.

3. The processor of claim 2, wherein:
the reading unit is further configured to simultaneously transfer the multiple pieces of input data to the MIMO executing unit; and
the MIMO executing unit is further configured to simultaneously transfer the multiple pieces of output data to the writing unit.

4. The processor of claim 1, wherein:
a plurality of the FUs are provided; and
the scheduler is further configured to map the multiple inputs and the multiple outputs to at least two FUs which are connected to each other.

5. The processor of claim 1, wherein the FU comprises two input register ports and one output register port.

6. The processor of claim 5, wherein the processor is configured to use a fixed bit instruction encoding.

7. The processor of claim 5, wherein the processor is configured to support a Very Long Instruction Word (VLIW).

8. A method of processing a Multiple Input Multiple Output (MIMO) instruction in a processor, the method comprising:
reading multiple pieces of input data from a register during a single cycle or during K sequential cycles, K being an integer greater than or equal to 2;
generating multiple pieces of output data by executing a MIMO operation during a predetermined number of cycles by use of the multiple pieces of input data; and
writing the multiple pieces of output data into a register during a single cycle or during L sequential cycles, L being an integer greater than or equal to 2,
wherein at least one of the reading of multiple pieces of input data and the writing of multiple pieces of output data is performed during a plurality of cycles.

9. The method of claim 8, wherein:
the processor comprises a plurality of functional units (FUs); and
the reading of multiple pieces of input data, the executing of MIMO operation, and the writing of multiple pieces of output data are performed by one of the plurality of FUs.

10. The method of claim 8, wherein:
the processor comprises a plurality of functional units (FUs); and
the reading of multiple pieces of input data and the writing of multiple pieces of output data are performed by at least two of the plurality of FUs that are connected to each other.

11. The method of claim 10, wherein the executing MIMO operation is performed by at least two of the plurality of FUs that are connected to each other.

12. The method of claim 8, wherein:
in the reading of multiple pieces of input data, at most two pieces of input data are read from the register at each of the K sequential cycles; and
in the writing of multiple pieces of output data, at most one piece of output data is written into the register at each of the K sequential cycles.

13. The method of claim 8, further comprising using a fixed bit instruction encoding.

14. The method of claim 8, further comprising supporting a Very Long Instruction Word (VLIW).

15. A method of processing a Multiple Input Multiple Output (MIMO) instruction in a processor, the method comprising at least one of:
processing multiple inputs of the MIMO instruction by reading a register during K sequential cycles, K being an integer greater than or equal to 2; and
processing multiple outputs of the MIMO instruction by executing a MIMO operation, and then writing a result of the MIMO operation into a register during L sequential cycles, L being an integer greater than or equal to 2.

16. The method of claim 15, further comprising performing scheduling in which at least one of:
the multiple inputs are mapped to the K sequential cycles; and
is the multiple outputs are mapped to the L sequential cycles.

17. The method of claim 16, wherein:
the processor comprises a plurality of functional units (FUs); and
the scheduling is performed such that the multiple inputs and the multiple outputs are processed by one of the plurality of FUs.

18. The method of claim 16, wherein:
the processor comprises a plurality of functional units (FUs); and
the scheduling is performed such that the multiple inputs and the multiple outputs are processed by at least two of the plurality of FUs which are connected to each other.

19. The method of claim 18, wherein the MIMO operation is performed by one of the at least two of the plurality of FUs that are connected to each other.

20. The method of claim 15, wherein:
the processor comprises a plurality of functional units (FU); and
each of the plurality of FUs:
reads at most two pieces of input data from the register for each cycle of the K sequential cycles; and
writes at most one piece of output data into the register for each cycle of the L sequential cycles.
